(19) United States
(12) Patent Application Publication
(10) Pub. No.: US 2013/0009438 A1
(43) Pub. Date: Jan. 10, 2013

(54) DRIVE UNIT FOR A VEHICLE SEAT

(75) Inventors: Jürgen Stemmer, Remscheid (DE); Michael Berres, Koeln (DE); Norbert Heeg, Dahn (DE); Jens Schulz, Kaiserslautern (DE); Andreas Diehl, Otterberg (DE)

(73) Assignee: Keiper GMBH & Co. KG, Kaiserslautern (DE)

(21) Appl. No.: 13/579,827

(22) PCT Filed: Feb. 1, 2011
(86) PCT No.: PCT/EP11/00456

§ 371 Date: Sep. 19, 2012

(30) Foreign Application Priority Data
Feb. 18, 2010 (DE) 10 2010 008 880.3

(51) Int. Cl. H02K 7/116; B60N 2/22

(52) U.S. Cl. 297/362; 74/421 A; 74/411.5; 475/337

(57) ABSTRACT

In a drive unit for a vehicle seat, having a motor which has a motor shaft as an output, and a multi-stage transmission which is driven by the motor shaft and which has an output shaft as an output, the transmission has at least one spur gear stage in which a drive wheel and an output gear, which are each embodied as spur gear wheels, mesh with one another, and the output shaft is arranged offset in parallel with the motor shaft.

The invention relates to a drive unit for a vehicle seat with the characteristics of the preamble of claim 1.

A drive unit of this type is known from DE 197 09 852 C2. The motor shaft carries a worm, which meshes with a worm wheel, which in turn drives a planetary stage as the output stage. The output shaft is arranged perpendicular to the motor shaft so that a certain installation space requirement exists. Such drive units serve to drive load-receiving transmissions that are integrated into the seat structure, transfer load in the event of a crash and serve to set seat components, for example as backrest adjustment fittings. DE 10 2004 019 466 A1 discloses another drive unit of this type, the transmission of which has a planetary stage, wherein the complete drive unit with motor and transmission is integrated into the center of the load-receiving transmission.

The object of the invention is to improve a drive unit of the initially named type, in particular with respect to cost and the requirement for installation space. This object is achieved according to the invention by a drive unit with the characteristics of claim 1. Advantageous embodiments are the subject of the dependent claims.

The parallel-offset arrangement of motor shaft and output shaft, which is achieved through the spur gear stage, has the advantage of less requirement for installation space diagonal to the output shaft compared to the perpendicular arrangement. Accordingly, the drive unit and the component of the vehicle seat driven by it, for example a backrest adjustment fitting, can be arranged along an axis, for example the swivel axis of the backrest.

The transmission ratio can be enlarged by several transmission stages one after the other, each of which has parallel drives and outputs. Spur gear stages and planetary stages (planetary transmission stages) are possible for this. Thus, the transmission can have for example at least one planetary stage, in which a sun gear serving as the drive meshes with planetary wheels, which mesh with a ring gear and are mounted on a bar, which serves as the output. The ring gear can form part of a transmission housing. The transmission can have for example exactly two planetary stages or exactly three spur gear stages or exactly four spur gear stages. A locking function can be realized for example in a form-fitting manner through a lock bolt or tooth segment or frictionally through a wrap spring.

The controller of the motor can be integrated into a transmission cover so that the motor still only contains basic electronics. The controller is preferably provided on a board with a uniform dimension (or a different component carrier) and demand-related with a different fitting. For example, the board can include the electronic components: radio interference suppression, thermal protection, overvoltage protection, if necessary position generator or position sensor, and decentralized motor control unit. In addition to this basic controller, a commutation controller for an EC motor can be provided, which are accommodated on another board, if necessary. The contact pins of the interface to the vehicle seat, which for example work together with a plug, are part of the board. The plug/socket geometry is realized on the transmission cover. According to the requirements with respect to the electrical integration, between two to five contact pins can be used for example. The board can be fitted on one or two sides. Certain components can be integrated into the basic electronics instead of into the board.

The different components and assemblies can preferably be plugged into each other, and namely preferably in the axial direction (direction of the motor shaft). With this modular structure of the drive unit, the assembly is greatly simplified. Thus, the motor with its basic electronics is preferably pluggable into the basic controller (or commutation controller) and/or with its motor shaft into the transmission, i.e. electrically and/or mechanically. The transmission cover is (mechanically) pluggable into the transmission housing. The said components and assemblies are preferably fastened additionally (or alternatively) on each other.

Below, the invention is explained in greater detail based on three exemplary embodiments shown in the drawing with modifications and variants. In the figures:

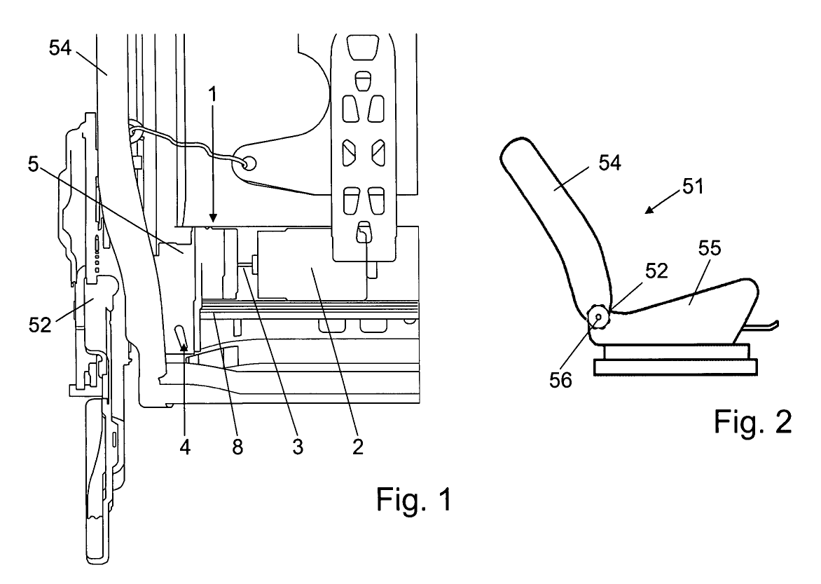

FIG. 1 shows a partial view of a vehicle seat with a drive unit,

FIG. 2 shows a schematic side view of the vehicle seat,

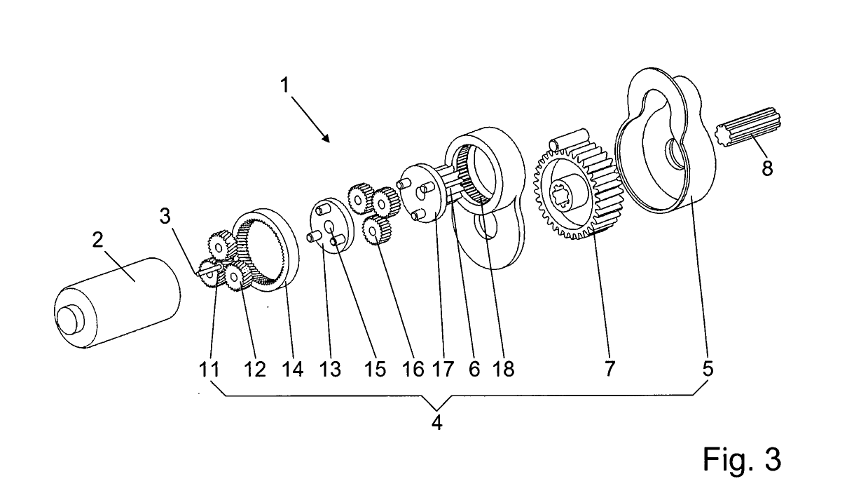

FIG. 3 shows an exploded view of the first exemplary embodiment,

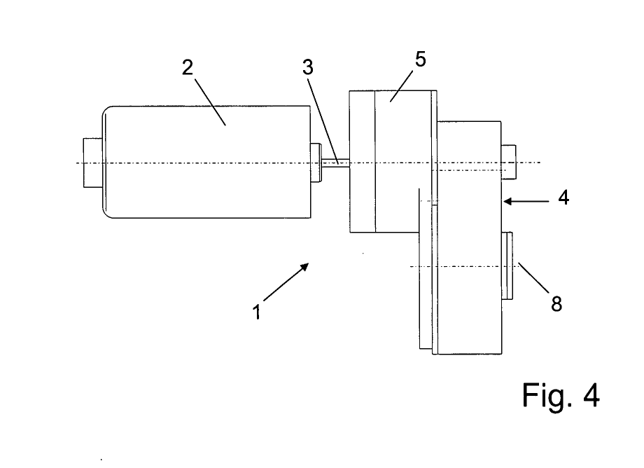

FIG. 4 shows a side view of the first exemplary embodiment,

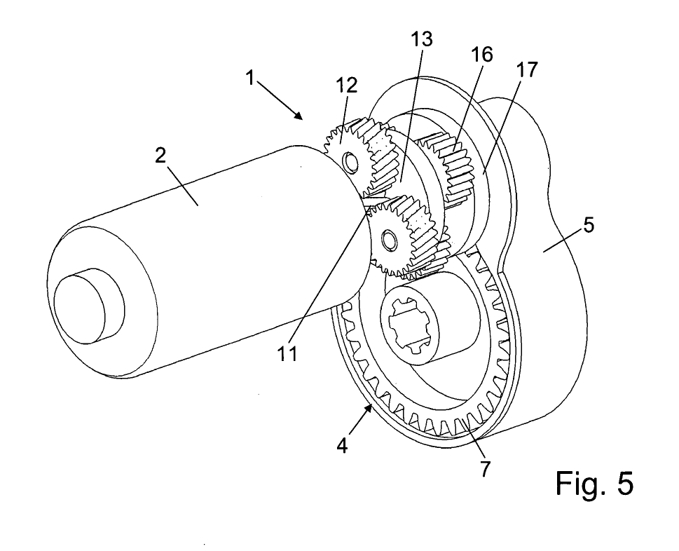

FIG. 5 shows a partially cut, perspective view of the first exemplary embodiment,

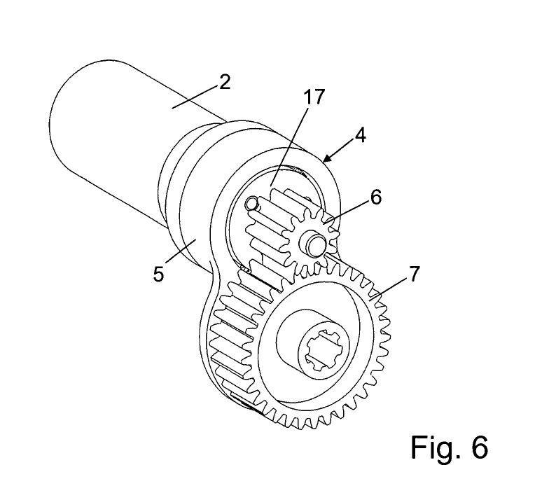

FIG. 6 shows a further, partially cut, perspective view of the first exemplary embodiment,

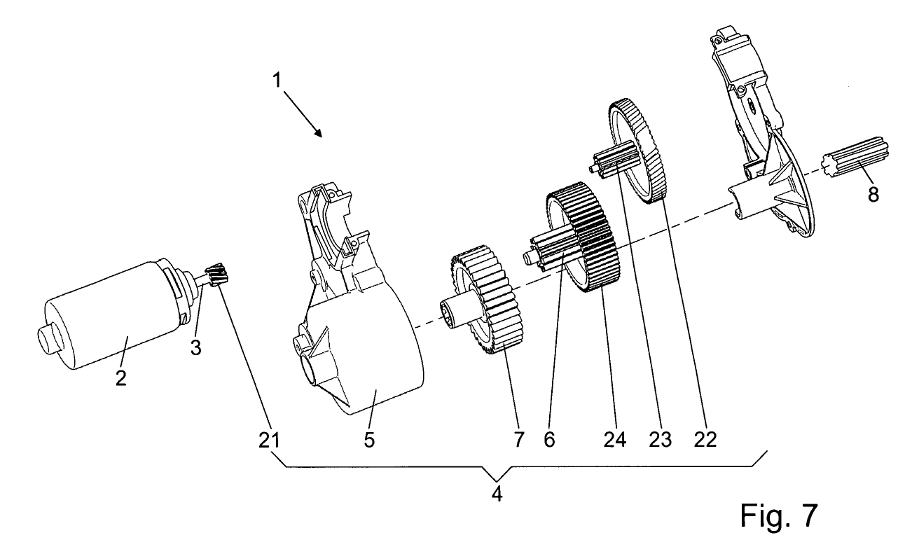

FIG. 7 shows an exploded view of the second exemplary embodiment,

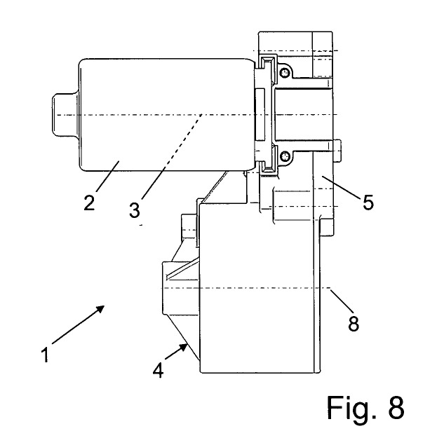

FIG. 8 shows a side view of the second exemplary embodiment,

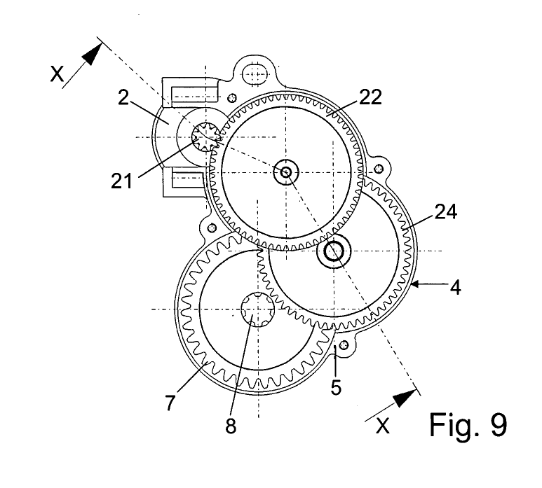

FIG. 9 shows a partially cut side view of the second exemplary embodiment,

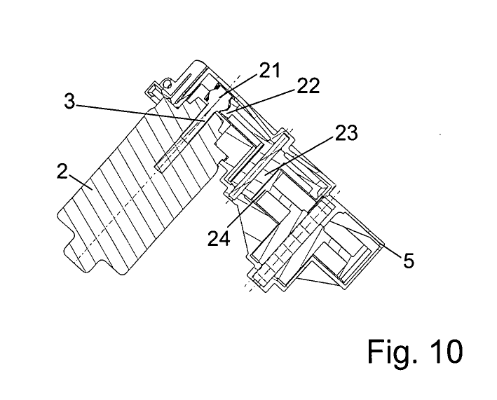

FIG. 10 shows a cut along the line X-X in FIG. 9,

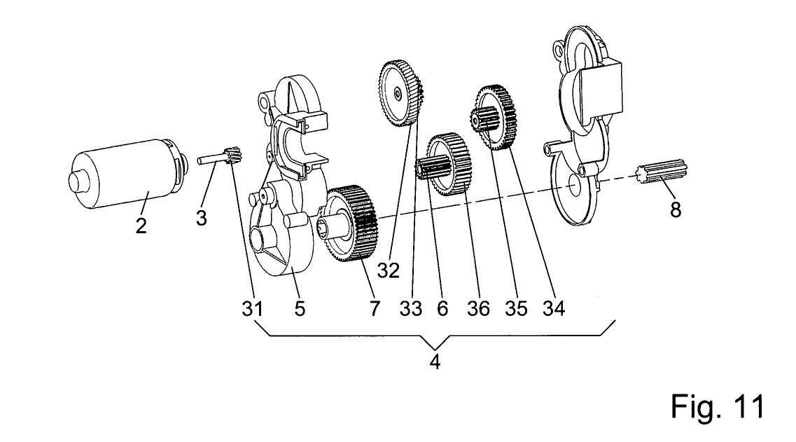

FIG. 11 shows an exploded view of the third exemplary embodiment,

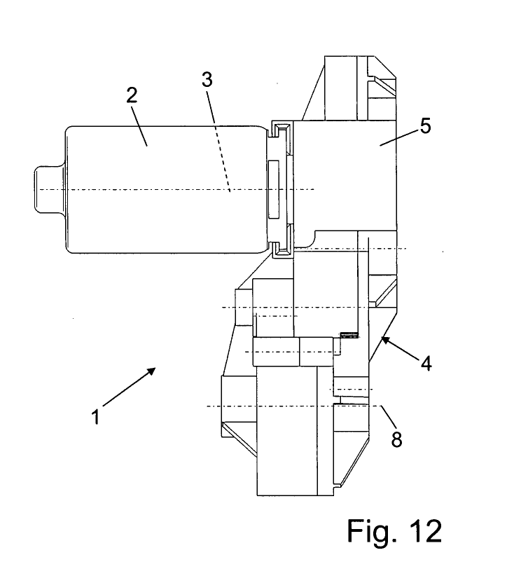

FIG. 12 shows a side view of the third exemplary embodiment,

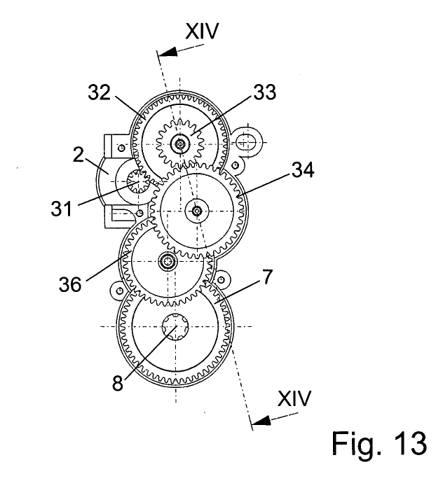

FIG. 13 shows a partially cut side view of the third exemplary embodiment,

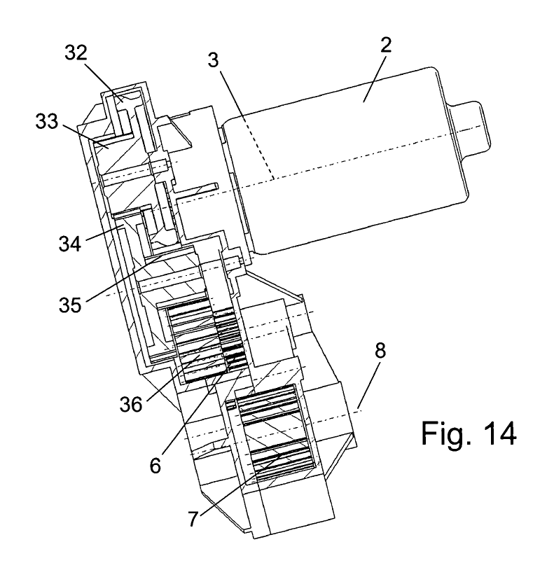

FIG. 14 shows a cut along the line XIV-XIV in FIG. 13,

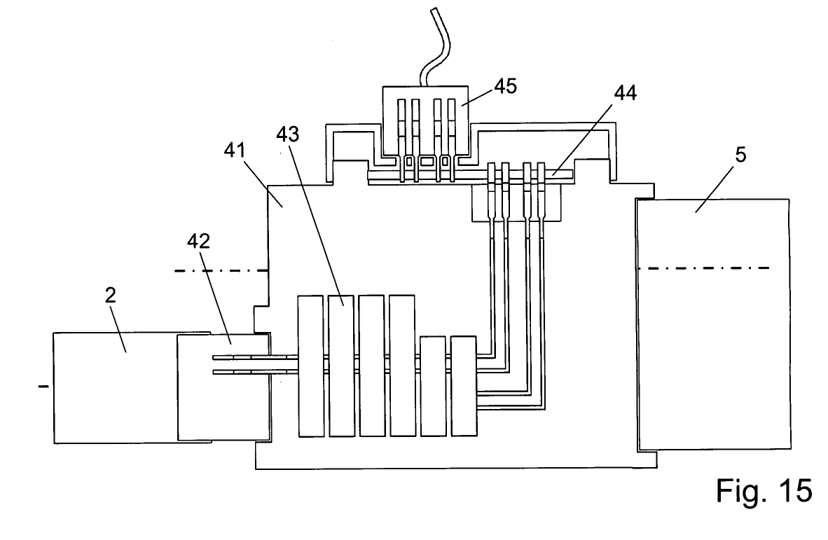

FIG. 15 shows a schematic representation of a transmission cover with commutation controller,

FIG. 16 shows a schematic representation of a transmission cover without commutation controller,

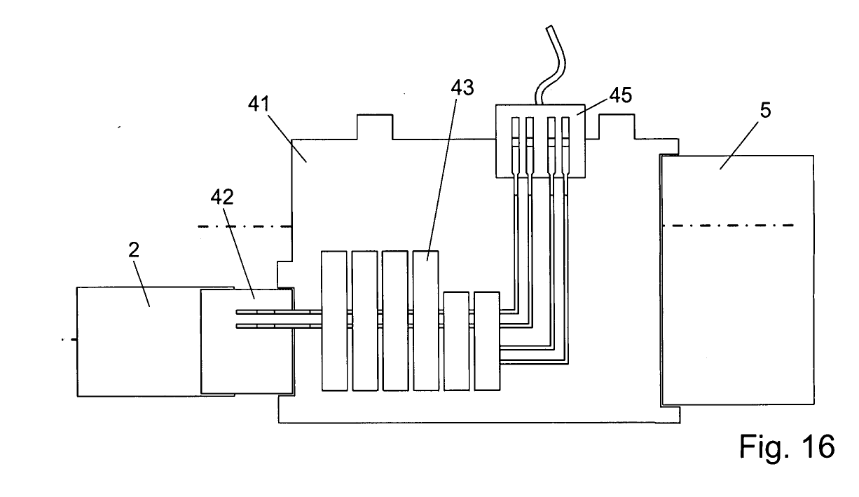

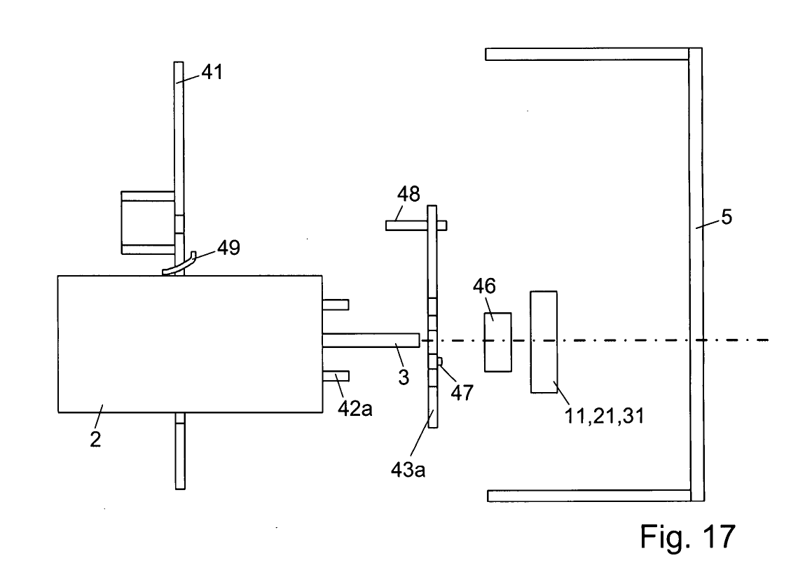

FIG. 17 shows a schematic representation before plugging in the motor,

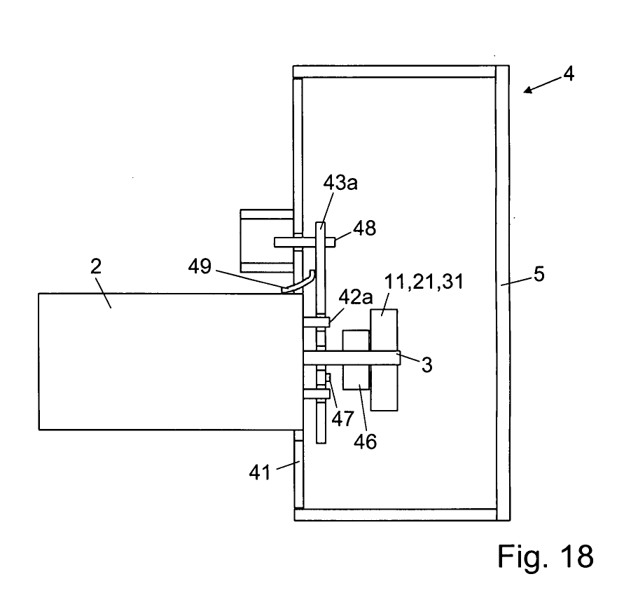

FIG. 18 shows a schematic representation after plugging in the motor,

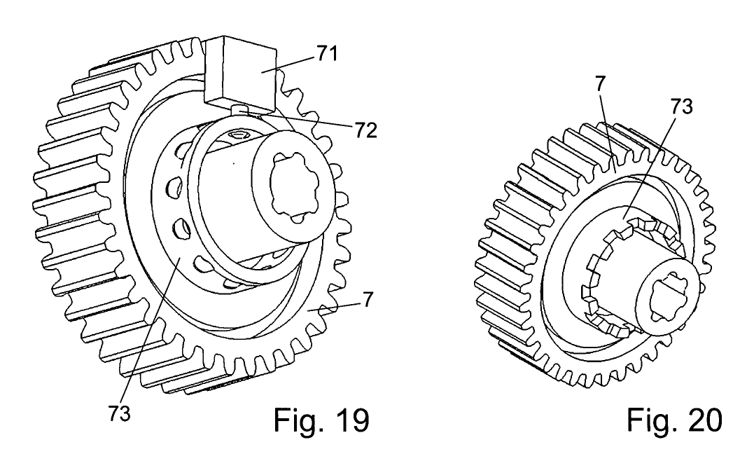

FIG. 19 shows a first variant of a locking function,

FIG. 20 shows a modification of the first variant,

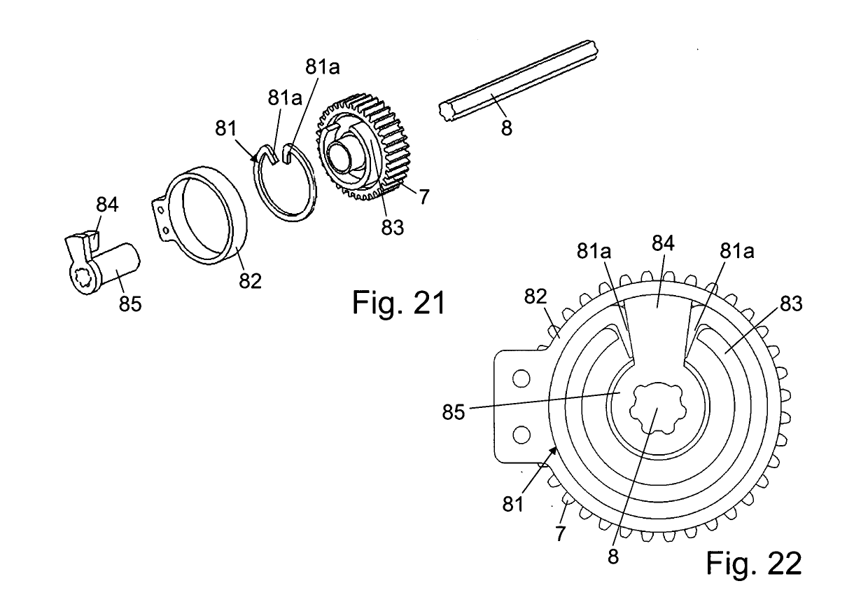

FIG. 21 shows an exploded view of a second variant of a locking function and

FIG. 22 shows a top view of the second variant.

A drive unit 1 has a motor 2, which is provided with a motor shaft 3 as the output. The motor 2 is for example an electronically commutated motor with a stator and a rotor, which defines the motor shaft 3. A brush-commutated motor 2 can also be used. The drive unit 1 also has a transmission 4, which is provided on the output side of the motor 2. The motor shaft 3 serves as the drive of the transmission 4. The motor 2 is preferably designed without integrated transmission stage, so that the entire reduction is performed by the transmission 4. A transmission housing 5, which is designed with multiple parts, surrounds the parts of the transmission 4. The motor 2 is preferably fastened on the transmission housing 5 so that the transmission housing 5 can also serve as a fastening of the drive unit 1 at its destination.

The transmission 4 is presently structured at least in three stages, i.e. at least three transmission stages are present, each of which reduces the rotation speed of the motor shaft 3 and transmits their torque. A transmission ratio i of 100 to 200, preferably 125 to 130, results in total for the transmission 4. A spur gear stage is provided as the output stage, consisting of two spur gear wheels rotatably mounted on the transmission housing 5 that mesh with each other and are straight-toothed, namely an output stage drive wheel 6 and an output stage output gear 7 with a greater diameter. A profiled (preferably designed as a spline shaft profile) output shaft 8 is connected in a torque-proof manner with the output stage output gear 7, for example in that the output stage output gear 7 has a profiled receiver according to the output shaft 8 in its center. The output shaft 8 serving as output of the transmission 4 is arranged offset in parallel with the motor shaft 3. The transmission 4 is designed non-self-locking, i.e. a torque introduced by the output shaft 8 would turn the motor shaft 3, and it has a high degree of efficiency. The motor 2 thus requires less torque (than in the case of a self-locking transmission) and can thus be designed small and light.

All exemplary embodiments are similar in this respect.

In the first exemplary embodiment, the transmission 4 has two planetary stages and a spur gear stage. The motor shaft 3 is connected in a torque-proof manner with a first sun gear 11 (or is formed integrally with it). Three first planetary wheels 12, which are rotatably mounted on a first bar 13, are arranged around the first sun gear 11. The first planetary wheels 12 mesh on the outside with a first ring gear 14, which is fixed and forms a part of the transmission housing 5. The first bar 13 serving as output of this first planetary stage is connected in a torque-proof manner with a second sun gear 15, which is integrally designed here with the first bar 13. Three second planetary wheels 16, which are rotatably mounted on a second bar 17, are arranged around the second sun gear 15. The first planetary wheels 16 mesh on the outside with a second ring gear 18, which is fixed and forms a part of the transmission housing 5. The second bar 17 serving as output for this second planetary stage is connected in a torque-proof manner with the output stage drive wheel 6.

In the second exemplary embodiment, the transmission 4 has three spur gear stages. The motor shaft 3 is connected in a torque-proof manner with an input drive wheel 21 (or is integrally designed with it). The input drive wheel 21 meshes with an input output gear 22 with a greater diameter. A helical toothing is hereby preferably provided, while the following spur gear stages are straight-toothed. A first intermediate drive wheel 23 with a smaller diameter is formed on the input output gear 22, i.e. is integrally designed with it. The first intermediate drive wheel 23 meshes with a first intermediate output gear 24 with a greater diameter. The output stage drive wheel 6 with a smaller diameter is formed on the first intermediate output gear 24, i.e. is integrally designed with it.

In the third exemplary embodiment, the transmission 4 has four spur gear stages. The motor shaft 3 is connected in a torque-proof manner with an input drive wheel 31 (or is integrally designed with it). The input drive wheel 31 meshes with an input output gear 32 with a greater diameter. A helical toothing is hereby preferably provided, while the following spur gear stages are straight-toothed. A first intermediate drive wheel 33 with a smaller diameter is formed on the input output gear 32, i.e. is integrally designed with it. The first intermediate drive wheel 33 meshes with a first intermediate output gear 34 with a greater diameter. A second intermediate drive wheel 35 with a smaller diameter is formed on the first intermediate output gear 34, i.e. is integrally designed with it. The second intermediate drive wheel 35 meshes with a second intermediate output gear 36 with a greater diameter. The output stage drive wheel 6 with a smaller diameter is formed on the second intermediate output gear 35, i.e. is integrally designed with it.

All exemplary embodiments have in common that a special interface can be established between motor 2 and transmission 4. A transmission cover 41 is provided for this, which is fastened on the transmission housing 5. The motor 2 only still contains, in addition to the mechanical components, such as for example the mounting, basic electronics 42, for example the connections for the brushes or the stator and, if applicable, a varistor. The basic controller 43 is arranged in the transmission cover 41 and has for example a Hall effect sensor for determining the rotor position. The basic controller 43 or the basic controller 42 preferably still contains one or several of the following functions: overload protection, overvoltage protection, thermal protection, (radio) interference suppression. The basic controller 43 can be arranged on a board 43a. Optionally, the basic controller 43 can also have fieldbus interfaces (for example CAN or LIN), a memory run, a soft start or a speed control. For electronically commutated motors 2, a commutation controller 44 is also provided, which is insertable in a shaft in the housing cover 41 in the case of a board design.

A plug 45, which is connected with the seat or vehicle electronics and the power supply, can be plugged into the housing cover 41. The plug 45 is preferably standardized (for example USB). For a modular structure, the plug 45 can optionally be plugged into the basic controller 43 or the commutation controller 44, wherein, in the case of the latter, the commutation controller 44 instead of the plug 45 is plugged into the basic controller 43.

The electrical plug-in system is expandable such that the motor 2 with its basic electronics 42 can be plugged into the basic controller 43 or, if applicable, into the commutation controller 44. The basic electronics 42 preferably has contacts 42a or soldering lugs for this, which contact corresponding counterpieces of the basic controller 43 or, if applicable, the commutation controller 44.

With the electrical plugging in of the motor 2 with its basic electronics 42, a mechanical plugging in of the motor 2 with its motor shaft 3 into the transmission 4 is also preferably associated. Depending on the exemplary embodiment, the motor shaft 3 engages in a torque-proof manner in the first sun gear 11 or the input drive wheel 21 or 31 (as sketched in the drawing), or this wheel 11, 21 or 31 is already seated permanently on the motor shaft 3 and upon plugging in comes in transmission engagement with the next transmission element, that is the first planetary wheels 12 or the input output gear 22 or 32. At the same time, the motor shaft 3 can also be plugged into a position generator 46, for example a magnet, which works together with a position sensor 47, for example a Hall effect sensor, which is provided on the basic controller 43 or the commutation controller 44.

In addition to the mechanical plugging in of the motor 2 and its motor shaft 3, a plugging in of the transmission cover 41 into the transmission housing 5 is preferably provided. The transmission cover 41 is first arranged for example on the motor 2 and upon plugging in comes in mechanical contact with the transmission housing 5. As sketched in the drawing, embodiments are also conceivable, in which the transmission cover 41 comes in electrical contact with the basic controller 43 or the commutation controller 44 upon plugging in of the motor 2, for which corresponding press-in contacts 48 are provided. It is also conceivable that a contact spring 49 establishes a chassis connection between the housing of the motor 2 and the basic controller 43 or the commutation controller 44.

The drive unit 1 according to the invention serves for example to drive a backrest adjustment fitting 52 in a vehicle seat 51, by means of which the incline of a backrest 54 is adjustable relative to a seat part 55. The backrest adjustment fitting 52 is designed self-locking in order to lock the non-self-locking transmission 4. Such a backrest adjustment fitting 52, which, as a load-receiving transmission, is integrated into the structure of the vehicle seat 51, is disclosed for example in DE 101 44 840 A1. The drive unit 1 can be arranged in an installation-space-saving manner along the swivel axis 56 of the backrest 54, wherein the output shaft 8 preferably aligns with the swivel axis 56. Additionally, a handwheel can be placed on the output shaft so that both an electrical as well as a manual adjustment of the backrest 54 is possible, especially since the transmission 4 is non-self-locking Accordingly, the handwheel or the motor 2 moves along empty.

All exemplary embodiments are preferably equipped with a locking function, in that the output stage output gear 7 and/or the output shaft 8 are fixable, for example on the transmission housing 5. Several variants are conceivable for this.

In a first variant, a magnetic switch 71 is provided, which is fastened on the transmission housing 5. The magnetic switch 71 provided with a plunger coil moves a lock bolt 72 in its longitudinal direction. The lock bolt 72 is effective in the radial direction, in that it is aligned with a locking ring 73, which has in the circumferential direction several radial bore holes for receiving the lock bolt 72. The locking ring 73 is (integrally) designed on the output stage output gear 7, i.e. out of the same material, or fastened on it. In the case of the latter, the locking ring 73 can be made of metal or high-strength plastic. In one modification, the locking ring 73 has no bore holes, but is rather designed as a crown wheel. In a further modification, the lock bolt 73 is effective axially. In a further modification, a movable tooth segment is provided instead of the lock bolt 72, which engages with a gear rim, for example on the locking ring 73, or with the external tooth system of the output stage output gear 7. In a further modification, the locking function takes place through a type of claw coupling.

In a second variant, a wrap spring 81 is provided, which is connected to a wrap-spring housing 82, here radially outward. The wrap-spring housing 82 is fastened on the transmission housing 5 or a part of it. The ends 81a of the wrap spring 81 point radially inward. A lug 83 is designed or fastened on output stage output gear 7, which extends in the circumferential direction between those sides of both ends 81a that face away from each other. A locking cam 84 is provided as a counterpiece, which is arranged between both of those ends 81a that face towards each other. The locking cam 84 is preferably designed or fastened on an output element 85, which sits in a torque-proof manner on the output shaft 8. A torque initiated by the motor side has an opening effect on the wrap spring 81 by means of the lug 83, in that it moves its ends 81a towards each other and thereby contracts the wrap spring 81 and releases it from the wrap spring housing 82. A torque initiated by the output side has a closing effect on the wrap spring 81 by means of the locking cam 84, in that it moves its ends 81a away from each other and thereby supports the connection of the pretensioned wrap spring 81 to the wrap spring housing 82. In one modification, the lug 83 is split into two and provided only at the two positions that should act on the ends 81a.

### REFERENCE LIST

1 Drive unit
2 Motor
3 Motor shaft
4 Transmission
5 Transmission housing
6 Output stage drive wheel
7 Output stage output gear
8 Output shaft
11 First sun gear
12 First planetary wheel
13 First bar
14 First ring gear
15 Second sun gear
16 Second planetary wheel
17 Second bar
18 Second ring gear
21, 31 Input drive wheel
22, 32 Input output gear
23, 33 First intermediate drive wheel
24, 34 First intermediate output gear
35 Second intermediate drive wheel
36 Second intermediate output gear
41 Transmission cover
42 Basic electronics
42a Contact
43 Basic controller
43a Board
44 Commutation controller
45 Plug
46 Position generator
47 Position sensor
48 Press-in contact
49 Contact spring
51 Vehicle seat
52 Backrest adjustment fitting
54 Backrest
55 Seat part
56 Swivel axis
71 Magnetic switch
72 Lock bolt
73 Locking ring
81 Wrap spring
81a End
82 Wrap spring housing
83 Lug
84 Locking cam
85 Output element

1. A drive unit for a vehicle seat, having a motor, which has a motor shaft as an output, and a multi-stage transmission, which is driven by the motor shaft and which has an output shaft as an output, wherein the transmission has at least one spur gear stage in which a drive wheel and an output gear, which are each embodied as spur gear wheels, mesh with one another, and in that the output shaft is arranged offset in parallel with the motor shaft.

2. The drive unit according to claim 1, wherein the transmission is designed non-self-locking.

3. The drive unit according to claim 1, wherein the transmission has a locking function.

4. The drive unit according to claim 1, wherein the transmission has at least a first planetary stage driven by the motor shaft, in particular a first planetary stage driven by the motor shaft and a second planetary stage output by this, for driving the spur gear stage.

5. The drive unit according to claim 1, wherein the transmission has a transmission housing, which at least surrounds the drive wheel and the output gear.

6. The drive unit according to claim 1, wherein a basic controller for the motor is assigned to a transmission cover of the transmission, while the motor contains basic electronics.

7. The drive unit according to claims 6, wherein the transmission cover can be at least one of plugged into the transmission housing and fastened on it.

8. The drive unit according to claim 6, wherein the transmission cover has a commutation controller for the electronically commutated motor.

9. The drive unit according to claim 6, wherein the motor with its basic electronics can be plugged into at least one of the basic controller and commutation controller.

10. The drive unit according to claim 1, wherein the motor with its motor shaft can be plugged into the transmission.

11. A vehicle seat, in particular motor vehicle seat, with a seat part, a backrest, which is adjustable by means of at least one backrest adjustment fitting in its inclination relative to the seat part, and a drive unit according to claim 1 for driving the backrest adjustment fitting.

12. The drive unit according to claim 6, wherein the basic controller for the motor is contained in the transmission cover of the transmission.
